(19) United States
(12) Patent Application Publication
(10) Pub. No.: US 2022/0129819 A1
(43) Pub. Date: Apr. 28, 2022

(54) ORGANIZATION OF SCRIPT PACKAGING SEQUENCE AND PACKAGING SYSTEM SELECTION FOR DRUG PRODUCTS USING AN ARTIFICIAL INTELLIGENCE ENGINE

(71) Applicant: PARATA SYSTEMS, LLC, Durham, NC (US)

(72) Inventors: Collin D. Blalock, Cary, NC (US); Richard Eckert, Lindenhurst, IL (US); Jenna May, Morrisville, NC (US); David A. Potochniak, Raleigh, NC (US); Peter Anwar Saad, Holly Springs, NC (US); Arthur F. Swanson, Cary, NC (US)

(21) Appl. No.: 17/510,635

(22) Filed: Oct. 26, 2021

Related U.S. Application Data
(60) Provisional application No. 63/106,043, filed on Oct. 27, 2020.

(51) Int. Cl. G06Q 10/06; G06Q 10/08; G06N 20/10

(52) U.S. Cl. CPC G06Q 10/06316; G06N 20/10; G06Q 10/06312; G06Q 10/087

(57) ABSTRACT

A method includes receiving a first plurality of batches, each of the first plurality of batches including a plurality of scripts identifying a plurality of drug products, respectively, and each of the first plurality of batches defining a first packaging sequence for the plurality of drug products identified by the plurality of scripts; receiving operational status information for each of a plurality of drug product packaging systems; and organizing, using an artificial intelligence engine, the plurality of scripts from the first plurality of batches into a second plurality of batches based on the operational status information received for each of the plurality of drug product packaging systems, the second plurality of batches defining a second packaging sequence for the plurality of drug products identified by the plurality of scripts.

### RELATED APPLICATIONS

The present application claims priority from and the benefit of U.S. Provisional Application No. 63/106,043, filed Oct. 27, 2020, the disclosure of which is hereby incorporated herein by reference in its entirety.

### BACKGROUND

The present disclosure relates generally to the dispensing of drug products, and, in particular, to methods, systems, and computer program products for managing multiple drug product and nutraceutical packaging systems.

Drug product packaging systems may be used in facilities, such as pharmacies, hospitals, long term care facilities, and the like to dispense medications to fill prescriptions. These drug product packaging systems may include systems designed to package medications in various container types including vials, bottles, blistercard, and strip packaging. Strip packaging is a type of packaging wherein medications are packaged in individual pouches for administration on a specific date and, in some cases, at a specific time. Typically, these pouches are removably joined together and often provided in rolls. The pouches can be separated from the roll when needed.

A packaging management system may receive a “batch” file from a pharmacy management system that includes several scripts to be filled for one or more patients. These files may be generated in a flat file format by the pharmacy management system and delivered to the packaging management system to process. The drug product packaging system may accept an order based on the batch file and will attempt to dispense the appropriate drug products from attached canisters or, for infrequently prescribed drug products, dispense the drug product from a manually filled tray. The drug product packaging system may fill each pouch, blistercard, bottle, or vial in sequence until the batch is complete or a drug product is unavailable to the drug product packaging system, e.g., a canister has run out or the drug product is unavailable to dispense via a tray. The batch orders are typically assigned to the drug product packaging systems without regard to the current operational state or workload of the drug product packaging systems, which can result in inefficiencies in filling the scripts contained in the batch orders.

### SUMMARY

In some embodiments of the inventive concept, a method comprises, receiving a first plurality of batches, each of the first plurality of batches comprising a plurality of scripts identifying a plurality of drug products, respectively, and each of the first plurality of batches defining a first packaging sequence for the plurality of drug products identified by the plurality of scripts; receiving operational status information for each of a plurality of drug product packaging systems; and organizing, using an artificial intelligence engine, the plurality of scripts from the first plurality of batches into a second plurality of batches based on the operational status information received for each of the plurality of drug product packaging systems, the second plurality of batches defining a second packaging sequence for the plurality of drug products identified by the plurality of scripts.

In other embodiments, the method further comprises communicating the second plurality of batches to the plurality of drug product packaging systems for packaging the plurality of drug products identified by the plurality of scripts.

In still other embodiments, the operational status information comprises a packaging order queue length, drug product inventory levels of canisters, respectively, and packaging error rates for each of the plurality of drug products.

In still other embodiments, the method further comprises identifying first features in the packaging order queue length and the drug product inventory levels of canisters that are predictive of time taken to process the second plurality of batches using the second packaging sequence by the plurality of drug product packaging systems; and identifying second features in the packaging error rates for each of the plurality of drug products that are predictive of packaging errors in processing the second plurality of batches using the second packaging sequence by the plurality of drug product packaging systems.

In still other embodiments, organizing, using an artificial intelligence engine, the plurality of scripts from the first plurality of batches into a second plurality of batches comprises organizing, using the artificial intelligence engine, the plurality of scripts from the first plurality of batches into the second plurality of batches by applying a modeling technique to the identified first and second features.

In still other embodiments, the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

In still other embodiments, the plurality of drug product packaging systems are owned by different operational control entities, respectively; the operational status information comprises drug product availability; availability of the respective drug product packaging system, and expense reimbursement rules; and at least one of the second plurality of batches includes an urgency indicator associated therewith.

In still other embodiments, the method further comprises determining, using the artificial intelligence engine, a packaging order distribution among the plurality of drug product packaging systems for the second plurality of batches based on the operational status information received for each of the plurality of drug product packaging systems and the urgency indicator.

In still other embodiments, the method further comprises communicating the second plurality of batches to the plurality of drug product packaging systems for packaging the plurality of drug products identified by the plurality of scripts based on the packaging order distribution.

In still other embodiments, the method further comprises identifying features in the drug product availability, the availabilities of the respective drug product packaging systems, and the expense reimbursement rules that are predictive of an ability to fulfill a packaging order.

In still other embodiments, determining, using the artificial intelligence engine, the packaging order distribution among the plurality of drug product packaging systems for the second plurality of batches comprises determining, using the artificial intelligence engine, the packaging order distribution among the plurality of drug product packaging systems for the second plurality of batches by applying a modeling technique to the identified features.

In still other embodiments, the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

In some embodiments of the inventive concept, a method comprises: receiving a plurality of batches, each of the plurality of batches comprising a plurality of scripts identifying a plurality of drug products, respectively, and each of the plurality of batches defining a packaging sequence for the plurality of drug products identified by the plurality of scripts, at least one of the plurality of batches includes an urgency indicator associated therewith; receiving operational status information for each of a plurality of drug product packaging systems; and determining, using the artificial intelligence engine, a packaging order distribution among the plurality of drug product packaging systems for the plurality of batches based on the operational status information received for each of the plurality of drug product packaging systems and the urgency indicator. The plurality of drug product packaging systems are owned by different operational control entities, respectively.

In further embodiments, the method further comprises communicating the plurality of batches to the plurality of drug product packaging systems for packaging the plurality of drug products identified by the plurality of scripts based on the packaging order distribution.

In still further embodiments, the operational status information comprises drug product availability; availability of the respective drug product packaging system, and expense reimbursement rules.

In still further embodiments, the method further comprises identifying features in the drug product availability, the availability of the respective drug product packaging system, and the expense reimbursement rules that are predictive of an ability to fulfill a packaging order.

In still further embodiments, determining, using the artificial intelligence engine, the packaging order distribution among the plurality of drug product packaging systems for the plurality of batches comprises determining, using the artificial intelligence engine, the packaging order distribution among the plurality of drug product packaging systems for the plurality of batches by applying a modeling technique to the identified features.

In still further embodiments, the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

In some embodiments of the inventive concept, a system comprises a processor and a memory coupled to the processor and comprising computer readable program code embodied in the memory that is executable by the processor to perform operations comprising receiving a first plurality of batches, each of the first plurality of batches comprising a plurality of scripts identifying a plurality of drug products, respectively, and each of the first plurality of batches defining a first packaging sequence for the plurality of drug products identified by the plurality of scripts; receiving operational status information for each of a plurality of drug product packaging systems; and organizing, using an artificial intelligence engine, the plurality of scripts from the first plurality of batches into a second plurality of batches based on the operational status information received for each of the plurality of drug product packaging systems, the second plurality of batches defining a second packaging sequence for the plurality of drug products identified by the plurality of scripts.

In some embodiments of the inventive concept, a system comprises a processor and a memory coupled to the processor and comprising computer readable program code embodied in the memory that is executable by the processor to perform operations comprising receiving a plurality of batches, each of the plurality of batches comprising a plurality of scripts identifying a plurality of drug products, respectively, and each of the plurality of batches defining a packaging sequence for the plurality of drug products identified by the plurality of scripts, at least one of the plurality of batches includes an urgency indicator associated therewith; receiving operational status information for each of a plurality of drug product packaging systems; and determining, using the artificial intelligence engine, a packaging order distribution among the plurality of drug product packaging systems for the plurality of batches based on the operational status information received for each of the plurality of drug product packaging systems and the urgency indicator. The plurality of drug product packaging systems are owned by different operational control entities, respectively.

Other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1A is a block diagram that illustrates a communication network including an Artificial Intelligence (AI) assisted batch processing and routing recommendation system for managing multiple drug product packaging systems in accordance with some embodiments of the inventive concept;

FIG. 1B is a block diagram that illustrates a communication network including an AI assisted batch processing and routing recommendation system for managing multiple drug product packaging systems spanning multiple owners including an AI assisted batch processing and routing recommendation system in accordance with some embodiments of the inventive concept

FIG. 2 is a block diagram of the AI assisted batch processing and routing recommendation system of FIGS. 1A and 1B in accordance with some embodiments of the inventive concept;

FIGS. 3-6 are flowcharts that illustrate operations for organizing a script packaging sequence and routing of batches to selected drug product packaging system using the AI assisted batch processing and routing recommendation system of FIGS. 1A and 1B in accordance with some embodiments of the inventive concept;

FIG. 7 is a data processing system that may be used to implement one or more servers in the AI assisted batch processing and routing recommendation system of FIGS. 1A and 1B in accordance with some embodiments of the inventive concept; and

FIG. 8 is a block diagram that illustrates a software/hardware architecture for use in the AI assisted batch processing and routing recommendation system of FIGS. 1A and 1B in accordance with some embodiments of the inventive concept.

### DETAILED DESCRIPTION

In the following detailed description, numerous specific details are set forth to provide a thorough understanding of embodiments of the present inventive concept. However, it will be understood by those skilled in the art that the present invention may be practiced without these specific details. In some instances, well-known methods, procedures, components and circuits have not been described in detail so as not to obscure the present inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “data processing facility” includes, but it is not limited to, a hardware element, firmware component, and/or software component. A data processing system may be configured with one or more data processing facilities.

The term “drug product packaging system,” as used herein, refers to any type of pharmaceutical dispensing system including, but not limited to, automated systems that fill vials, bottles, containers, pouches, blistercards, or the like with drug product, and semi-automated systems that fill vials, bottles, containers, pouches, blistercards, or the like with drug product. Drug product packaging system also includes packaging systems for pharmaceutical alternatives, such as nutraceuticals and/or bioceuticals.

The terms “pharmaceutical” and “medication,” as used herein, are interchangeable and refer to medicaments prescribed to patients either human or animal.

The term “drug product” refers to any type of medicament that can be packaged within a vial, bottle, container, pouch, blistercard, or the like by automated and semi-automated drug product packaging systems including, but not limited to, pills, capsules, tablets, caplets, gel caps, lozenges, and the like. Drug product also refers to pharmaceutical alternatives, such as nutraceuticals and/or bioceuticals. Example drug product packaging systems including management techniques for fulfilling packaging orders are described in U.S. Pat. No. 10,492,987 the disclosure of which is hereby incorporated herein by reference.

Embodiments of the inventive concept are described herein in the context of a recommendation engine that includes a machine learning engine and an artificial intelligence (AI) engine. It will be understood that embodiments of the inventive concept are not limited to a machine learning implementation of the prediction engine and other types of AI systems may be used including, but not limited to, a multi-layer neural network, a deep learning system, a natural language processing system, and/or computer vision system Moreover, it will be understood that the multi-layer neural network is a multi-layer artificial neural network comprising artificial neurons or nodes and does not include a biological neural network comprising real biological neurons.

Some embodiments of the inventive concept stem from a realization that managing drug product packaging systems without regard to their current operational status may result in inefficiencies when filling batch orders containing multiple scripts for one or more patients. Embodiments of the inventive concept may provide an AI assisted batch processing and routing recommendation system that takes into account the operational status of the drug product packaging systems used for processing the orders contained in one or more batches. For example, the AI assisted batch processing and routing recommendation system may be used to receive one or more batches of scripts for fulfillment by a plurality of drug product packaging systems and to organize the scripts in those batches in a sequence that may be more efficient to fill based on a variety of different types of operational status information for the drug product packaging systems. This operational status information may include, but is not limited to, packaging order queue length, drug product inventory levels of canisters, and/or packaging error rates for one or more of the drug products being packaged. In some embodiments, the different drug product packaging systems may be owned by different operational control entities. Nevertheless, it may be possible based on rules and agreements reached between various entities to communicate orders to a drug product packaging system owned by another entity. In other embodiments, the different drug product packaging systems may be located in different facilities and may be under the control of different pharmacy and/or packaging management systems, but may owned by a common entity. This may further improve efficiency in fulfilling drug product packaging orders as it may increase the number of drug product packaging systems available as candidates for filling the orders. Thus, in some embodiments of the inventive concept, the AI assisted batch processing and routing recommendation system may be used to determine a packaging order distribution among a plurality of drug product packaging systems where the drug product packaging systems are not owned by the same operational control entity. One or more batches of scripts can be communicated to the drug product packaging systems for packaging the drug products identified by the scripts contained therein based on the packaging order distribution. In some embodiments, the AI assisted batch processing and routing recommendation system may organize the scripts contained in the one or more batches to change the drug product packaging sequence to improve efficiency as described above before communicating the one or more batches of scripts to the drug product packaging systems based on the packaging order distribution. In some embodiments the AI assisted batch processing and routing recommendation system may determine the packaging order distribution based on operational status information for drug product packaging systems along with an urgency indicator. The operational status information may include, but is not limited to, drug product availability, availability of the respective drug product packaging systems, and expense reimbursement rules. The urgency indicator may provide information that can be used to advance the a particular script for a particular drug product ahead in a queue of packaging orders due to, for example, a patient emergency. The urgency indicator may also be a factor in where a script is filled. For example, an urgent prescription may be filled at a convenient location for delivery to the patient.

Thus, the AI assisted batch processing and routing recommendation system may be used to improve the efficiency in packaging drug products by organizing the script sequence in one or more batches based on the operational status of the drug product packaging systems. This may reduce the likelihood that a drug product packaging system runs out of a particular drug product when filling a packaging order, that canisters have to be changed out because a canister containing a particular drug product was not currently loaded in the drug product packaging system, that fewer instances of manual intervention are required to load a particular drug product via a tray, and/or that packaging errors occur for various error prone drug products or packaging sequence. Moreover, the AI assisted batch processing and routing recommendation system may be used to improve the efficiency in packaging drug products by evaluating and taking into account the operational status of drug product packaging systems that may be owned by different operational control entities. This increases the number of drug product packaging options, which can in turn increase the efficiency of fulfilling drug product packaging orders.

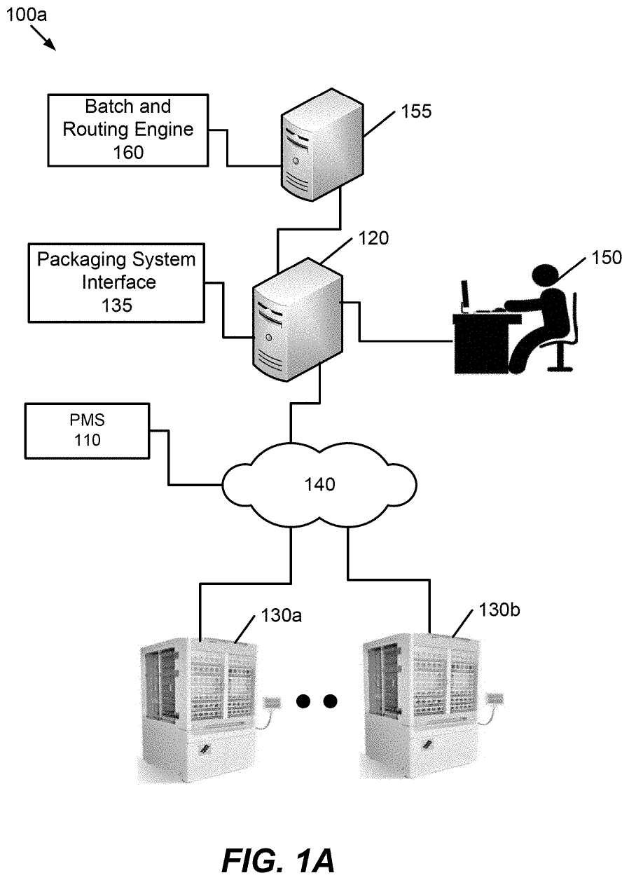

Referring to FIG. 1A, a communication network 100a including an AI assisted batch processing and routing recommendation system, in accordance with some embodiments of the inventive concept, comprises a pharmacy management system (PMS) or host system 110, a packaging system server 120, a batch and routing engine server 155, and multiple drug product packaging systems 130a and 130b that are coupled via a network 140 as shown.

The PMS system 110 may be configured to manage and fill prescriptions for customers. As used herein, PMS systems may be used in pharmacies or may be used generally as batch-generating systems for other applications, such as dispensing nutraceuticals or bioceuticals. The PMS system 110 may be associated with a variety of types of facilities, such as pharmacies, hospitals, long term care facilities, and the like. The packaging system server 120 may include a packaging system interface module 135 and may be configured to manage the operation of the drug product packaging systems 130a and 130b. For example, the packaging system server 120 may be configured to receive packaging orders from the PMS system 110 and to identify which of the drug product packaging systems 130a and 130b should be used to package particular individual orders or batches of orders. In addition, the packaging system server 120 may be configured to manage the operations of the drug product packaging systems 130a and 130b. For example, the packaging system server 120 may be configured to manage the inventory of drug product available through each of the drug product packaging systems 130a and 130b, to manage the drug product dispensing canisters assigned or registered to one or more of the drug product packaging systems 130a and 130b, to manage the operational status generally of the drug product packaging systems 130a and 130b, and/or to manage reports regarding the status (e.g., assignment, completion, etc.) of packaging orders, drug product inventory, order billing, and the like. A user 150, such as a pharmacist or pharmacy technician, may communicate with the packaging system server 120 using any suitable computing device via a wired and/or wireless connection. Although the user 150 is shown communicating with the packaging system server 120 via a direct connection in FIG. 1, it will be understood that the user 150 may communicate with the packaging system server 120 via one or more network connections. The user 150 may interact with the packaging system server 120 to approve or override various recommendations made by the packaging system server 120 in operating the drug product packaging systems 130a and 130b. The user 150 may also initiate the running of various reports as described above for the drug product packaging systems 130a and 130b. Although only two drug product packaging systems 130a and 130b are shown in FIG. 1A, it will be understood that more than two drug product packaging systems may be managed by the packaging system server 120.

The AI assisted batch processing and routing recommendation system may include the batch and routing engine server 155, which includes a batch and routing engine module 160 to facilitate organizing the scripts contained in one or more batches into a new batch sequence that may be more efficient based on the operational status of the drug product packaging systems 130a and 130b. The batch and routing engine server 155 and batch and routing engine module 160 may further facilitate routing of batches containing one or more scripts for packaging based on a packaging order distribution, which defines how the batches are distributed among multiple drug product packaging systems 130a and 130b.

It will be understood that the division of functionality described herein between the packaging system server 120/packaging system interface module 135 and the batch and routing engine server 155/batch and routing engine module 160 is an example. Various functionality and capabilities can be moved between the packaging system server 120/packaging system interface module 145 and the batch and routing engine server 155/batch and routing engine module 160 in accordance with different embodiments of the inventive concept. Moreover, in some embodiments, the packaging system server 120/packaging system interface module 145 and the batch and routing engine server 155/batch and routing engine module 160 may be merged as a single logical and/or physical entity.

A network 140 couples the drug product packaging systems 130a and 130b, the PMS system 110, and the packaging system server 120 to one another. The network 140 may be a global network, such as the Internet or other publicly accessible network. Various elements of the network 150 may be interconnected by a wide area network, a local area network, an Intranet, and/or other private network, which may not be accessible by the general public. Thus, the communication network 140 may represent a combination of public and private networks or a virtual private network (VPN). The network 140 may be a wireless network, a wireline network, or may be a combination of both wireless and wireline networks.

The AI assisted batch processing and routing recommendation service provided through the packaging system server 120, packaging system interface module 135, batch and routing engine server 155, and batch and routing engine module 160, in some embodiments, may be implemented as a cloud service. In some embodiments, the AI assisted batch processing and routing recommendation service may be implemented as a Representational State Transfer Web Service (RESTful Web service). The batch and routing engine module 160 and packaging system interface module 135 may further provide an interface for communicating the batch sequence and packaging order distribution recommendations for the drug product packaging systems to, for example, a pharmacy or facility manager, e.g., user 150.

Referring to now to FIG. 1B, a communication network 100b including an AI assisted batch processing and routing recommendation system, in accordance with some embodiments of the inventive concept is the same as the communication network 100a of FIG. 1A with the exception that the drug product packaging systems are owned by different operational control entities. As shown in FIG. 1B, drug product packaging systems 130a and 130b are part of Facility 1, which is owned by a first operational control entity and managed by PMS 110a, and drug product packaging systems 131a and 131b are part of Facility 2, which is owned by a second operational control entity and managed by PMS 110b. According to some embodiments of the inventive concept, the batch and routing engine server 155 and batch and routing engine module 160 may be used to determine a packaging order distribution among a plurality of drug product packaging systems where the drug product packaging systems are not owned by the same operational control entity. In other embodiments, the drug product packaging systems 130a and 130b, which are part of Facility 1, and the drug product packaging systems 131a and 131b, which are part of Facility 2, may be located in separate geographic locations and may be managed by separate pharmacy management systems and/or packaging control systems (e.g., PMS 110a and PMS 110b), but may nevertheless by owned by a common entity.

Although FIGS. 1A and 1B illustrate example communication networks that include AI assisted batch processing and routing recommendation systems for packaging drug products, it will be understood that embodiments of the inventive subject matter are not limited to such configurations, but are intended to encompass any configuration capable of carrying out the operations described herein.

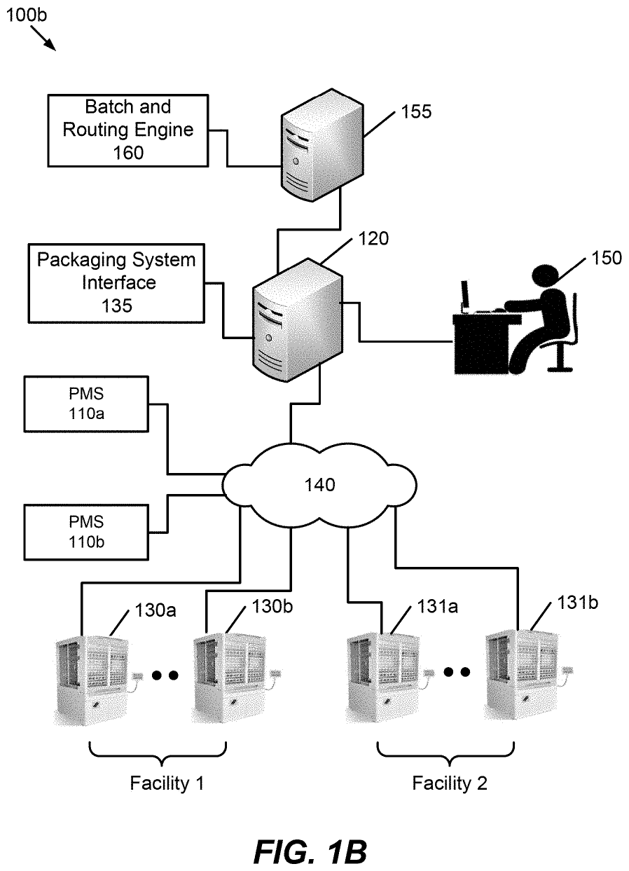

FIG. 2 is a block diagram of the batch and routing engine module 160 used in the AI assisted batch processing and routing recommendation system in accordance with some embodiments of the inventive concept. As shown in FIG. 2, the batch and routing engine 145 may include both training modules and modules used for processing new data on which to make batch packaging sequence and packaging system routing recommendations. The modules used in the training portion of the batch and routing engine module 160 include the training data module 205, the featuring module 225, the labeling module 230, and the machine learning engine 240. The training data 205 may comprise information associated with the drug products to be packaged, which may be identified by National Drug Code (NDC). The drug product information may include, but is not limited to, error rate information during packaging, frequency of use, e.g., distribution of drug product among patient scripts, and type of packaging used for the drug product. The training data 205 may further comprise information on the operational status of the drug product packaging systems used to package the drug products. The operational status information may include, but is not limited to, packaging order queue lengths, drug product inventory levels of canisters, and packaging error rates for the different drug products on the various drug product packaging systems. In embodiments in which the drug product packaging systems are owned by different operational entities, the operational status information may further include drug product availability on the various drug product packaging systems, the availability of the various drug product packaging systems to process batches from facilities owned by a different entity, for example, and expense reimbursement rules between the entities owning the different drug product packaging systems. The featuring module 225 is configured to identify the individual independent variables that are used by the batch and routing engine module 160 to make recommendations, which may be considered a dependent variable. For example, the training data 205 may be generally unprocessed or formatted and include extra information in addition to drug product and/or drug product packaging system information. For example, the training data 205 may include account codes, business address information, and the like, which can be filtered out by the featuring module 225. The features extracted from the training data 205 may be called attributes and the number of features may be called the dimension. The labeling module 230 may be configured to assign defined labels to the training data and to the generated recommendations to ensure a consistent naming convention for both the input features and the predicted outputs. The machine learning engine 240 may process both the featured training data 205, including the labels provided by the labeling module 230, and may be configured to test numerous functions to establish a quantitative relationship between the featured and labeled input data and the predicted outputs. The machine learning engine 240 may use modeling techniques to evaluate the effects of various input data features on the predicted outputs. These effects may then be used to tune and refine the quantitative relationship between the featured and labeled input data and the predicted outputs. The tuned and refined quantitative relationship between the featured and labeled input data generated by the machine learning engine 240 is output for use in the AI engine 245. The machine learning engine 240 may be referred to as a machine learning algorithm.

The modules used for processing new data on which to make batch packaging sequence and packaging system routing recommendations include the new data module 255, the featuring module 265, the AI engine module 245, and the batch/routing recommendation module 275. The new data 255 may be the same data/information as the training data 205 in content and form except the data will be used for an actual recommendation. Likewise, the featuring module 265 performs the same functionality on the new data 255 as the featuring module 225 performs on the training data 205. The AI engine 245 may, in effect, be generated by the machine learning engine 240 in the form of the quantitative relationship determined between the featured and labeled input data and the output recommendation. The AI engine 245 may, in some embodiments, be referred to as an AI model. The AI engine 245 may be configured to output recommendations for organizing drug product packaging sequences in batches and/or for routing batches to one or more drug product packaging systems, which may be owned by different operational control entities via the batch/routing recommendation module 275. The batch/routing recommendation module 275 may be configured to communicate the recommendation to the packaging system server 120 of FIGS. 1A and 1B, for example, where it can be automatically executed or reviewed by a user 150 and modified. Parameters that may be indicative of the performance of one or more of the drug product packaging systems in packaging batches that are organized based on the recommended sequences generated by the AI engine may be used to train the machine learning engine 240 as additional training data 205. For example, packaging error rates, time taken to package various batches, numbers of canister swaps, number of manual tray fills, and the like may be used to evaluate the efficacy of a batch packaging sequence recommendation. Likewise, when routing batches for packaging among multiple drug product packaging systems that may be owned by different owners factors such as reimbursement costs (e.g., overhead associated with reimbursing the re-stocking cost for another facility's drug product inventory), packaging fulfillment times (speed in getting a batch order packaged at another facility versus waiting in a queue at a current facility), and/or packaging error rates may be used to evaluate the efficacy of the a batch routing recommendation.

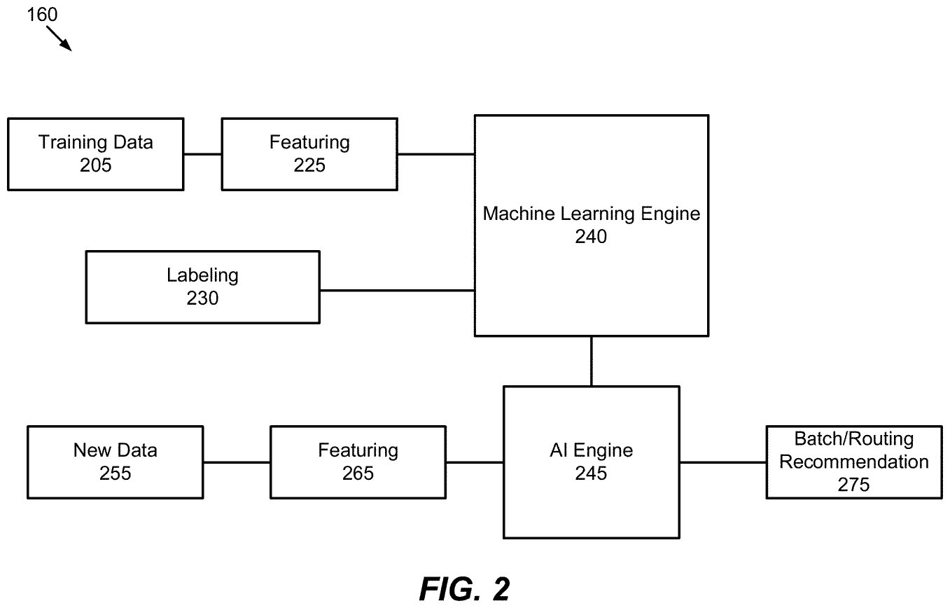

FIGS. 3-6 are flowcharts that illustrate operations for organizing a script packaging sequence and routing of batches to selected drug product packaging system using the AI assisted batch processing and routing recommendation system of FIGS. 1A and 1B in accordance with some embodiments of the inventive concept. Referring to FIG. 3, operations begin at block 300 where the AI engine 245 receives a first plurality of batches with each of the batches comprising a plurality of scripts identifying a plurality of drug products, respectively. Each batch defines a packaging sequence for the drug products identified by the scripts therein. At block 305, the AI engine 245 receives operational status information for each of the drug product packaging systems 130a, 130b, 131a, 131b. The operational status information may include, but is not limited to, packaging order queue length, drug product inventory levels of canisters, respectively, and packaging error rates for each of the plurality of drug products. The AI engine 245 may then organize the scripts from the first plurality of batches into a second plurality of batches that includes a second packaging sequence based on the operational status information at block 310. The second plurality of batches may be communicated as one or more packaging orders to one or more of the drug packaging systems 130a, 130b, 131a, and 131b for fulfillment.

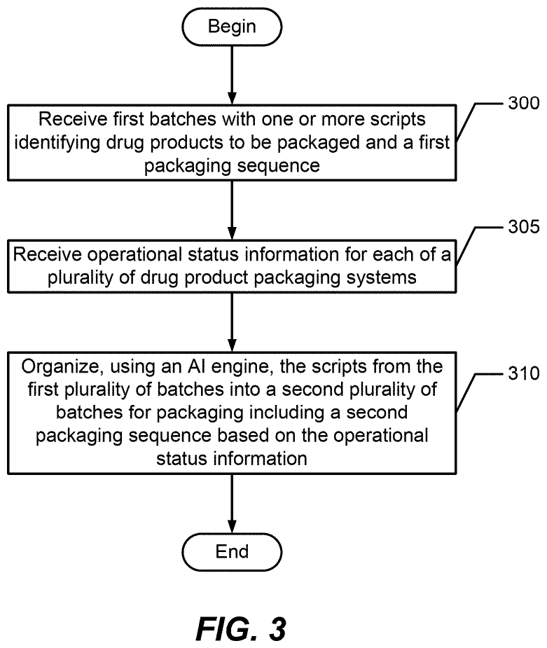

As described above with respect to FIG. 2, the batch and routing engine module 160 may include both training modules and modules used for processing new data on which to make event predictions. The modules used in the training portion of the batch and routing engine module 160 include the training data 205, the featuring module 225, the labeling module 230, and the machine learning engine 240. Referring now to FIG. 4, the machine learning engine 240 is configured to receive training data 205 that may be featured using the featuring module 225. At block 400, first features are identified in the packaging order queue length and the drug product inventory levels of canisters that are predictive of time taken to process the second plurality of batches using the second packaging sequence by the plurality of drug product packaging systems. At block 405, second features are identified in the packaging error rates for each of the plurality of drug products that are predictive of packaging errors in processing the second plurality of batches using the second packaging sequence by the plurality of drug product packaging systems. The AI engine 245 may then organize the scripts from the first plurality of batches into the second plurality of batches with the second packaging sequence by applying a modeling technique to the first and second features at block 410. The modeling technique may be embodied in various ways in accordance with different embodiments of the inventive concept including, but not limited to, a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

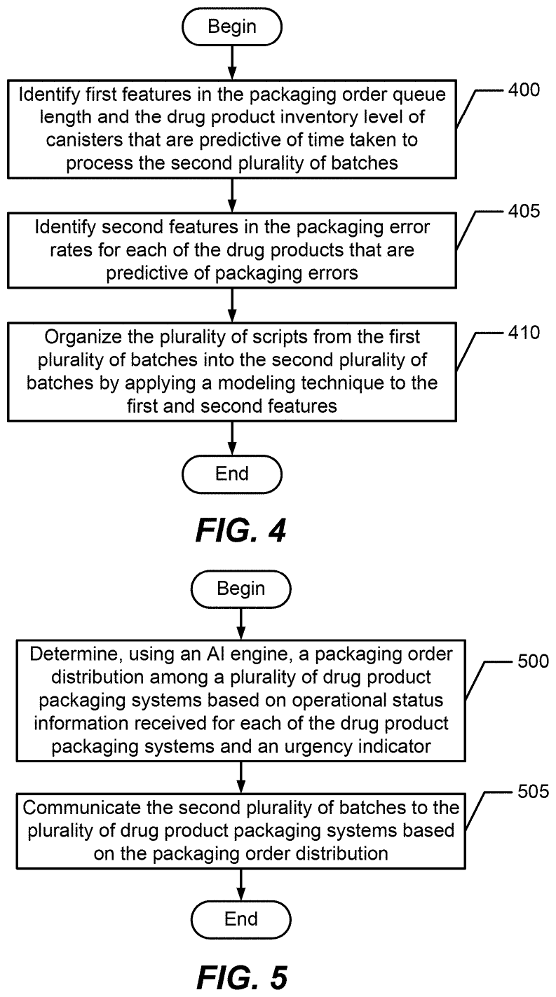

As described above with respect to FIG. 1B, the drug product packaging systems may be owned by different operational control entities or may be in different locations and managed by different control systems, but owned by a same entity. As shown in FIG. 1B, drug product packaging systems 130a and 130b are part of Facility 1, which is owned by a first operational control entity and managed by PMS 110a, and drug product packaging systems 131a and 131b are part of Facility 2, which is owned by a second operational control entity and managed by PMS 110b. Referring now to FIG. 5, the AI engine 245 may determine a packaging order distribution among the plurality of drug product packaging systems 130a, 130b, 131a, and 131a where drug product packaging systems 130a, 130b, 131a, and 131b are not owned by the same operational control entity based on operational status information received for each of the drug product packaging systems and an urgency indicator at block 500. The operational status information may include, but is not limited to, drug product availability, availability of a respective drug product packaging system, and/or expense reimbursement rules. Moreover, in some embodiments, one or more of the batches may have an urgency indicator associated therewith, which may be used to advance a particular script for a particular drug product ahead in a queue of packaging orders due to, for example, a patient emergency.

The second plurality of batches may be communicated as one or more packaging orders to one or more of the drug packaging systems 130a, 130b, 131a, and 131b for fulfillment based on the packaging order distribution at block 505. In other embodiments, the batches may be communicated to drug packaging systems 130a, 130b, 131a, and 131b that are not owned by the same operational control entity without modifying the packaging sequence based on the operational status of the drug packaging systems 130a, 130b, 131a, and 131b as described above.

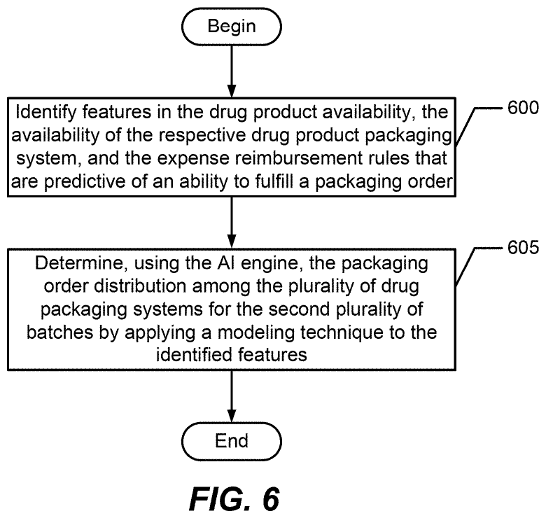

As described above with respect to FIGS. 2 and 4, the machine learning engine 240 is configured to receive training data 205 that may be featured using the featuring module 225. Referring now to FIG. 6, at block 600, features are identified in the drug product availability, the availabilities of the respective drug product packaging systems, and the expense reimbursement rules that are predictive of an ability to fulfill a packaging order. At block 605 the AI engine 245 is used to determine the packaging order distribution among the drug packaging systems 130a, 130b, 131a, and 131b, which are not owned by the same operational control entity, by applying a modeling technique to the identified features at block 600. Similar to block 410 of FIG. 4, The modeling technique may be embodied in various ways in accordance with different embodiments of the inventive concept including, but not limited to, a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

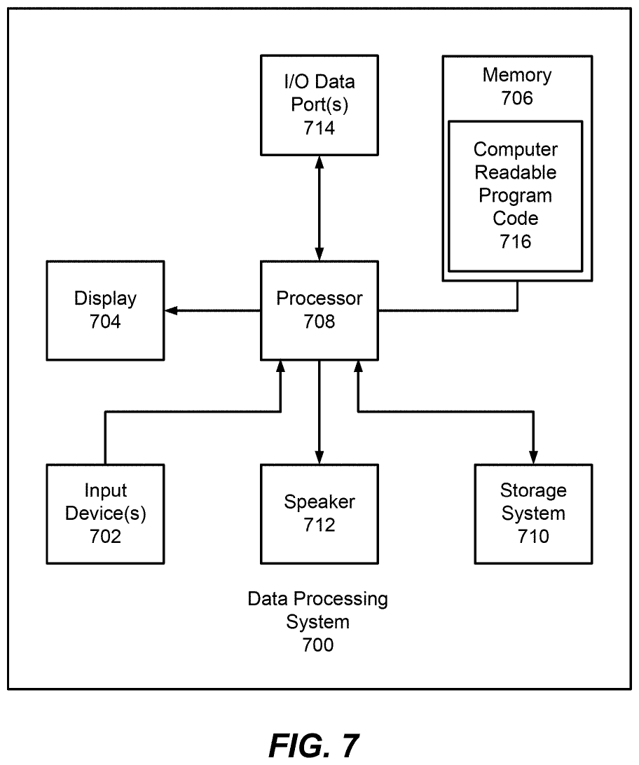

Referring now to FIG. 7, a data processing system 700 that may be used to implement the batch and routing engine server 155 of FIG. 1, in accordance with some embodiments of the inventive concept, comprises input device(s) 702, such as a keyboard or keypad, a display 704, and a memory 706 that communicates with a processor 708. The data processing system 700 may further include a storage system 710, a speaker 712, and an input/output (I/O) data port(s) 714 that also communicate with the processor 708. The processor 708 may be, for example, a commercially available or custom microprocessor. The storage system 710 may include removable and/or fixed media, such as floppy disks, ZIP drives, hard disks, or the like, as well as virtual storage, such as a RAMDISK. The I/O data port(s) 714 may be used to transfer information between the data processing system 700 and another computer system or a network (e.g., the Internet). These components may be conventional components, such as those used in many conventional computing devices, and their functionality, with respect to conventional operations, is generally known to those skilled in the art. The memory 706 may be configured with computer readable program code 716 to facilitate AI assisted script packaging sequencing and batch routing of scripts to drug product packaging systems according to some embodiments of the inventive concept.

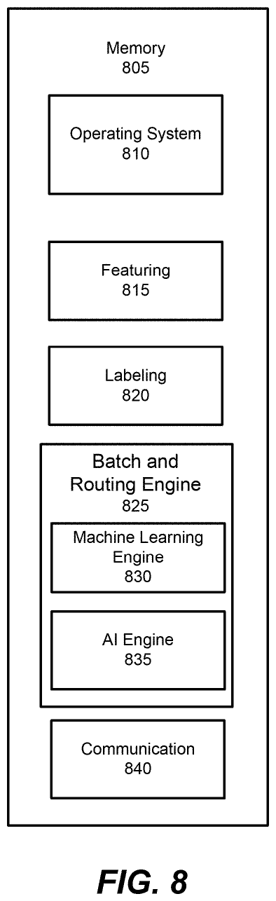

FIG. 8 illustrates a memory 805 that may be used in embodiments of data processing systems, such as the batch and routing engine server 155 of FIG. 1 and the data processing system 700 of FIG. 7, respectively, to facilitate AI assisted script packaging sequencing and batch routing of scripts to drug product packaging systems according to some embodiments of the inventive concept. The memory 805 is representative of the one or more memory devices containing the software and data used for facilitating operations of the batch and routing engine server 155 and the batch and routing engine module 160 as described herein. The memory 805 may include, but is not limited to, the following types of devices: cache, ROM, PROM, EPROM, EEPROM, flash, SRAM, and DRAM. As shown in FIG. 8, the memory 805 may contain five or more categories of software and/or data: an operating system 810, a featuring module 815, a labeling module 820, a batch and routing engine module 825, and a communication module 840. In particular, the operating system 810 may manage the data processing system's software and/or hardware resources and may coordinate execution of programs by the processor. The featuring module 815 may be configured to perform one or more of the operations described above with respect to the featuring modules 225, 265 and the flowcharts of FIGS. 3-6. The labeling module 820 may be configured to perform one or more of the operations described above with respect to the labeling module 230 and the flowcharts of FIGS. 3-6. The prediction engine batch and routing engine module 825 may comprise a machine learning engine module 830 and an AI engine module 835. The machine learning engine module 830 may be configured to perform one or more operations described above with respect to the machine learning engine 240 and the flowcharts of FIGS. 3-6. The AI engine module 835 may be configured to perform one or more operations described above with respect to the AI engine 245 and the flowcharts of FIGS. 3-6. The communication module 840 may be configured to support communication between, for example, the batch and routing engine server 155 and the packaging system interface server 120.

Although FIGS. 7-8 illustrate hardware/software architectures that may be used in data processing systems, such as the batch and routing engine server 155 of FIGS. 1A and 1B and the data processing system 700 of FIG. 7, respectively, in accordance with some embodiments of the inventive concept, it will be understood that embodiments of the present invention are not limited to such a configuration but is intended to encompass any configuration capable of carrying out operations described herein.

Computer program code for carrying out operations of data processing systems discussed above with respect to FIGS. 1A, 1B, and 2-8 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the batch and routing engine server 155 of FIGS. 1A and 1B and the data processing system 700 of FIG. 7 may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.”

The data processing apparatus described herein with respect to FIGS. 1-8 may be used to facilitate AI assisted script packaging sequencing and batch routing of scripts to drug product packaging systems according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 805 when coupled to a processor includes computer readable program code that, when executed by the processor, causes the processor to perform operations including one or more of the operations described herein with respect to FIGS. 1A, 1B, and 2-6.

As described above, embodiments of the inventive concept may provide an AI assisted batch processing and routing recommendation system that may be used to improve the efficiency in packaging drug products by organizing the script sequence in one or more batches based on the operational status of the drug product packaging systems. This may reduce packaging latency as well as errors that may occur during the packaging for certain drug products or types of packaging sequences. Moreover, the AI assisted batch processing and routing recommendation system may be used to improve the efficiency in packaging drug products by taking into account the operational status of drug product packaging systems that may be owned by different operational control entities. This increases the number of drug product packaging options, which may allow packaging orders to be fulfilled more rapidly and by a drug product packaging system that may be best suited for a particular batch.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “include”, “including”, “includes”, “have”, “has”, “having”, or variants thereof when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will also be understood that, although the terms first, second, etc. may be used herein to describe various elements, these elements should not be limited by these terms. These terms are only used to distinguish one element from another.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
receiving a first plurality of batches, each of the first plurality of batches comprising a plurality of scripts identifying a plurality of drug products, respectively, and each of the first plurality of batches defining a first packaging sequence for the plurality of drug products identified by the plurality of scripts;
receiving operational status information for each of a plurality of drug product packaging systems; and
organizing, using an artificial intelligence engine, the plurality of scripts from the first plurality of batches into a second plurality of batches based on the operational status information received for each of the plurality of drug product packaging systems, the second plurality of batches defining a second packaging sequence for the plurality of drug products identified by the plurality of scripts.

2. The method of claim 1, further comprising:
communicating the second plurality of batches to the plurality of drug product packaging systems for packaging the plurality of drug products identified by the plurality of scripts.

3. The method claim 1, wherein the operational status information comprises a packaging order queue length, drug product inventory levels of canisters, respectively, and packaging error rates for each of the plurality of drug products.

4. The method of claim 3, further comprising:
identifying first features in the packaging order queue length and the drug product inventory levels of canisters that are predictive of time taken to process the second plurality of batches using the second packaging sequence by the plurality of drug product packaging systems; and
identifying second features in the packaging error rates for each of the plurality of drug products that are predictive of packaging errors in processing the second plurality of batches using the second packaging sequence by the plurality of drug product packaging systems.

5. The method of claim 3, wherein organizing, using an artificial intelligence engine, the plurality of scripts from the first plurality of batches into a second plurality of batches comprises:
organizing, using the artificial intelligence engine, the plurality of scripts from the first plurality of batches into the second plurality of batches by applying a modeling technique to the identified first and second features.

6. The method of claim 5, wherein the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

7. The method of claim 1, wherein the plurality of drug product packaging systems are owned by different operational control entities, respectively;
wherein the operational status information comprises drug product availability; availability of the respective drug product packaging system, and expense reimbursement rules; and
wherein at least one of the second plurality of batches includes an urgency indicator associated therewith.

8. The method of claim 7, further comprising:
determining, using the artificial intelligence engine, a packaging order distribution among the plurality of drug product packaging systems for the second plurality of batches based on the operational status information received for each of the plurality of drug product packaging systems and the urgency indicator.

9. The method of claim 8, further comprising:
communicating the second plurality of batches to the plurality of drug product packaging systems for packaging the plurality of drug products identified by the plurality of scripts based on the packaging order distribution.

10. The method of claim 8, further comprising:
identifying features in the drug product availability, the availabilities of the respective drug product packaging systems, and the expense reimbursement rules that are predictive of an ability to fulfill a packaging order.

11. The method of claim 10, wherein determining, using the artificial intelligence engine, the packaging order distribution among the plurality of drug product packaging systems for the second plurality of batches comprises:
determining, using the artificial intelligence engine, the packaging order distribution among the plurality of drug product packaging systems for the second plurality of batches by applying a modeling technique to the identified features.

12. The method of claim 11, wherein the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

13. A method comprising:
receiving a plurality of batches, each of the plurality of batches comprising a plurality of scripts identifying a plurality of drug products, respectively, and each of the plurality of batches defining a packaging sequence for the plurality of drug products identified by the plurality of scripts, at least one of the plurality of batches includes an urgency indicator associated therewith;
receiving operational status information for each of a plurality of drug product packaging systems; and
determining, using an artificial intelligence engine, a packaging order distribution among the plurality of drug product packaging systems for the plurality of batches based on the operational status information received for each of the plurality of drug product packaging systems and the urgency indicator;
wherein the plurality of drug product packaging systems are owned by different operational control entities, respectively.

14. The method of claim 13, further comprising:
communicating the plurality of batches to the plurality of drug product packaging systems for packaging the plurality of drug products identified by the plurality of scripts based on the packaging order distribution.

15. The method of claim 13, wherein the operational status information comprises drug product availability; availability of the respective drug product packaging system, and expense reimbursement rules.

16. The method of claim 15, further comprising:
identifying features in the drug product availability, the availability of the respective drug product packaging system, and the expense reimbursement rules that are predictive of an ability to fulfill a packaging order.

17. The method of claim 16, wherein determining, using the artificial intelligence engine, the packaging order distribution among the plurality of drug product packaging systems for the plurality of batches comprises:
determining, using the artificial intelligence engine, the packaging order distribution among the plurality of drug product packaging systems for the plurality of batches by applying a modeling technique to the identified features.

18. The method of claim 17, wherein the modeling technique comprises a regression technique, a neural network technique, an Autoregressive Integrated Moving Average (ARIMA) technique, a deep learning technique, a linear discriminant analysis technique, a decision tree technique, a naïve Bayes technique, a K-nearest neighbors technique, a learning vector quantization technique, a support vector machine technique, and/or a bagging/random forest technique.

19. A system, comprising:
a processor; and
a memory coupled to the processor and comprising computer readable program code embodied in the memory that is executable by the processor to perform operations comprising:
receiving a first plurality of batches, each of the first plurality of batches comprising a plurality of scripts identifying a plurality of drug products, respectively, and each of the first plurality of batches defining a first packaging sequence for the plurality of drug products identified by the plurality of scripts;
receiving operational status information for each of a plurality of drug product packaging systems; and
organizing, using an artificial intelligence engine, the plurality of scripts from the first plurality of batches into a second plurality of batches based on the operational status information received for each of the plurality of drug product packaging systems, the second plurality of batches defining a second packaging sequence for the plurality of drug products identified by the plurality of scripts.

20. A system, comprising:
a processor; and
a memory coupled to the processor and comprising computer readable program code embodied in the memory that is executable by the processor to perform operations comprising:
receiving a plurality of batches, each of the plurality of batches comprising a plurality of scripts identifying a plurality of drug products, respectively, and each of the plurality of batches defining a packaging sequence for the plurality of drug products identified by the plurality of scripts, at least one of the plurality of batches includes an urgency indicator associated therewith;
receiving operational status information for each of a plurality of drug product packaging systems; and
determining, using an artificial intelligence engine, a packaging order distribution among the plurality of drug product packaging systems for the plurality of batches based on the operational status information received for each of the plurality of drug product packaging systems and the urgency indicator;
wherein the plurality of drug product packaging systems are owned by different operational control entities, respectively.
